(19) United States
(12) Patent Application Publication
(10) Pub. No.: US 2005/0201734 A1
(43) Pub. Date: Sep. 15, 2005

(54) Small screenless portable DVD player having picture signal and sound signal combination terminal

(76) Inventors: Yoshiaki Kimura, Tokyo (JP); Totetu Li, Tokyo (JP); Shigeru Kumada, Tokyo (JP); Shigetoshi Chiwaki, Kanagawa (JP)

Correspondence Address: Thomas M. Freiburger, P.O. Box 1026, Tiburon, CA, 94120, US

(21) Appl. No.: 10/942,677

(22) Filed: Sep. 15, 2004

(30) Foreign Application Priority Data
Mar. 12, 2004 (JP) 2004-113653

(51) Int. Cl. H04N 5/91

(52) U.S. Cl. 386/96

(57) ABSTRACT

A better way of replaying a video picture, using a small screenless portable DVD player, is disclosed. As a handy and easy way of charging a mobile telephone is also described by using the screen of the mobile telephone as a screen for a small screenless portable DVD player, and by connecting the small screenless portable DVD player with the mobile telephone with only one cable which transmits both picture signal and sound signal, use of the mobile to play DVDs is made easier. Moreover, by providing a USB terminal that provides electric power from the battery pack of the small screenless portable DVD player, on the side of the DVD player, and by charging electric power to the battery of the mobile telephone through this USB terminal, the mobile telephone is conveniently charged by the ordinarily larger battery of the DVD player.

### BACKGROUND OF THE INVENTION

The present invention relates to a DVD player and specifically relates a small portable DVD player which doesn't contain a display screen.

A DVD player is widely used as a means of playing back the DVD disk where pictures and sound were recorded in high density.

The size of a DVD player was almost the same as an ordinary video deck at the first stage of the product, and a display screen part wasn't equipped onto the player. Usually a TV screen took care of this part.

However, improvement of the technology realized the miniaturization of the parts for portable DVD, so-called screen integrated type in which a display screen is equipped onto a player.

The liquid crystal display screen is generally used for a display screen for an ordinary display such as TV and PC. It is one of the causes why the portable DVD with built-in display became possible, the appearance of this liquid crystal screen.

Moreover, a very small portable DVD which doesn't contain a display screen which emphasizes mobile capability is becoming available. For example, DVD-PV 40, manufactured by Matsushita Electric Co., Ltd., has been released. A portable DVD player which doesn't contain this display part is called a small screenless portable DVD player in the present invention.

Typical mobile equipment which is widely used at the present time is a mobile telephone.

The progress of the mobile telephone was remarkable. The mobile telephone with the camera became popular, and even the mobile telephone with a tuner with which a TV picture can be seen has been released. (For example, the mobile telephone named “V601N” which is produced by VODA FONE CO., Ltd.). Concerning the mobile telephone, use time is increasing and the use interval becomes longer every year. Various functions are being added to mobile telephones and the consumption of electric power is increased as a whole. For this reason, the mobile telephone often faces exhaustion of battery power. The portable battery charger is provided to meet with such a situation.

To see a replaying picture using a small screenless portable DVD player as commercially available, it usually is connected with an ordinary TV or with a personal computer with a screen. It has also been connected to the mobile telephone described above, requiring a special adapter or coupling circuit. But, such use has not been in a manner as makes best use of the mobile capability of a small screenless portable DVD player. A better way of replaying a picture, using a small screenless portable DVD player, is strongly needed. As for the mobile telephone, a handy and easy way of charging, which is another item of importance, is strongly needed.

### SUMMARY OF THE INVENTION

The first purpose of this invention is to provide a small screenless portable DVD player in which picture and sound from the portable DVD player can easily and conveniently be replayed using the mobile telephone. The second purpose of this invention is to provide a small screenless portable DVD player which is capable of charging the electric battery of the mobile telephone. The third purpose of this invention is to provide a cable with which a battery of a mobile telephone can be charged.

In the present invention, by using the screen of the mobile telephone as a screen of a small screenless portable DVD player, and by connecting the small screenless portable DVD player with the mobile telephone with only one cable which transmits both picture signal and sound signal, the problem above mentioned is solved.

Moreover, in the present invention, by providing a USB terminal, which provides electric power from the battery pack of the small screenless portable DVD player, on the side of the DVD player, and by charging electric power to a battery of a mobile telephone through this USB terminal, the above mentioned charging problem of the mobile telephone is solved.

### DESCRIPTION OF THE DRAWING

FIG. 1 is a block diagram showing the present invention.

### DETAILED DESCRIPTION OF A PREFERRED EMBODIMENT OF THE INVENTION

In the drawing, numeral 1 is a DVD player, numeral 2 is a power supply, numeral 3 is a picture signal, numeral 4 is a sound signal, numerals 5 and 6 are a sound signal output terminal and a picture signal output terminal which are optionally provided, numeral 7 is an AC coupling circuit, numeral 8 is a picture signal/sound signal combination terminal, numeral 9 is a picture signal/sound signal combination cable, numeral 9a is a picture signal/sound signal combination connector, numeral 10 is a plain-type connector for a stereo earphone, numeral 11 is a mobile telephone with a tuner, numeral 12 is a DC-DC converter, numeral 13 is a USB terminal, numeral 14 is a USB connector and numeral 15 is a cable for charging to a battery of the mobile telephone. Not all components of the DVD player 1 or the mobile telephone 11 are represented.

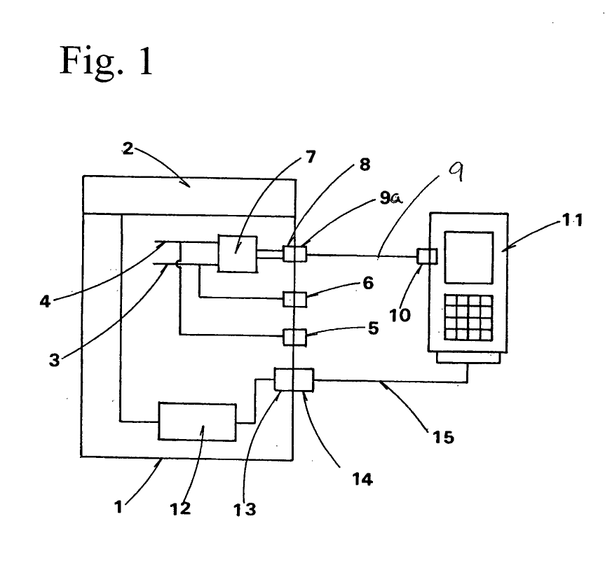

In an ordinary small screenless portable DVD player, a sound signal output terminal 5 and a picture signal output terminal 6 are separately equipped and those terminals are connected separately to a screen using individual cables (not shown in FIG. 1). In the present invention, by using the screen of the mobile telephone as a screen of a small screenless portable DVD player, and by connecting the small screenless portable DVD player with the mobile telephone with only one cable which transmits both picture signal and sound signal, replaying of both picture and sound signal from a small screenless portable DVD player is made easier. The separate sound and picture terminals 5 and 6 preferably still are provided, in case the typical screen as in prior use is to be connected.

In the present invention, picture signals 3 and sound signals 4 are led to the AC coupling circuit 7 in a player and undergo adjusting of output level. After adjusting of output level, both signals are led to a picture signal/sound signal combination terminal 8. The picture signal/sound signal combination terminal 8 is used to combine two cables (a cable for a picture signal and a cable for a sound signal) into one cable 9. A picture signal/sound signal combination connector 9a, is connected to a plain-type connector for the stereo earphone 10 of the mobile telephone 11 with this single cable 9. The mobile telephone which is used in the present invention is the mobile telephone with a tuner, as discussed above, capable of receiving DVD picture and sound. The picture signal/sound signal combination terminal 8 has at least three electric contact points. A terminal 10 on the side of the mobile telephone is a plain-type connector for the stereo earphone which is used usually for replaying the stereo sound, having three contact points, but which is also capable of receiving DVD picture/sound signals as discussed above.

Preferably the picture/sound terminals on both the DVD player and the mobile telephone (as well as the cable connectors) have coaxial contacts, meaning either contacts at different radius or contacts at a single radius but different as isolated longitudinal positions (or a combination of both).

The line voltage of the battery for driving the DVD player is different from the voltage of the battery for operating the mobile telephone. For example in BDV-0101 which is manufactured by BLUEDOT Co., Ltd., the line voltage of the cell for driving this DVD player is 9 volts. On the other hand the voltage of the cell for operating a mobile telephone is generally 5.6 volts in Japan. On many typical small portable DVD players the battery pack is a separate component that can be secured to the DVD player, and is electrically connected by a wire or by contacts. The battery for the DVD is shown at 2.

In the present invention, by providing a USB terminal 13, which provides electric power from a battery pack of the small screenless portable DVD player, equipped on the side of the DVD player, and by charging electric power to the battery of the mobile telephone through this USB terminal, it becomes possible to charge a battery of a mobile telephone. By DC-DC converter 12, a part of power of the line voltage of the cell for driving the DVD player is dropped to a voltage which is the same as for operating the mobile telephone. An electric current with dropped voltage is fed to the USB terminal 13. The USB terminal 13 is used to supply power at the appropriate voltage to the connected mobile telephone. The USB terminal 13 is combined with a USB terminal connector 14 which is connected with the terminal of the mobile telephone for charging via the charging cable 15. This charging cable is used when the mobile telephone needs charging.

By the present invention, it becomes easier to replay the picture and sound from a small screenless portable DVD player, with a mobile telephone, and at the same time to charge the mobile telephone.

The present invention promotes the advantages of the mobile capability of a portable DVD player and of a mobile telephone and will create a new use field.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

1. A small screenless portable DVD player having a battery and having internal means for generating a picture signal and a sound signal, and including a combination picture signal/sound signal terminal positioned on an exterior surface of the portable DVD player, receiving both the picture signal and the sound signal and being adapted to receive an end connector of a single cable for connection to a portable device capable of playing a DVD sound and picture.

2. The portable DVD player of claim 1, including a battery and further including a USB terminal at an external surface of the DVD player, connected to the battery of the portable DVD player, for use in charging such a portable device.

3. The portable DVD player of claim 1, wherein the portable device comprises a mobile telephone with a screen and with a terminal capable of receiving picture and sound signals from a small screenless portable DVD player.

4. A small screenless portable DVD player having a battery and having at least one USB terminal on an exterior surface of the player, connected to the battery, capable of charging a mobile telephone using the battery of the DVD player.

5. The portable DVD player of claim 4, further including means in the DVD player for changing voltage output at the USB terminal, so that the voltage at the USB terminal is different from the voltage of the battery in the DVD player.

6. A small screenless portable DVD player having a battery and internal means for generating at least one picture signal and at least one sound signal, with a combination terminal on an exterior surface of the DVD player connected to receive both the picture signal and the sound signal, and a power terminal on an exterior surface of the DVD player and connected to the battery, for use in charging another portable device.

7. The portable DVD player of claim 6, in combination with a mobile telephone having a battery and a screen and having an external connection for a stereo earphone and also for the input of DVD picture and sound signals to the mobile telephone, and a single cable connecting the combination picture/sound terminal of the portable DVD player to the stereo earphone terminal of the mobile telephone to convey both picture and sound signals through the single cable, and a further cable with two ends, one adapted to connect to the power terminal on the portable DVD player and the other end adapted to connect to a power input in the mobile telephone, for charging the battery of the mobile telephone using the battery of the portable DVD player.

8. A cable device for connecting a mobile telephone to play video and audio from a small portable DVD player, comprising:
a cable with a cable covering sheath containing at least three conductors, and
the cable having two ends, one having a first connector with three contacts for mating with a single combination picture/sound terminal on a small portable DVD player, and the other end having a second connector for mating with a three-contact stereo earphone terminal on a mobile telephone, such stereo earphone terminal being capable of receiving picture and sound signals from a screenless portable DVD player.

9. The cable device of claim 8, wherein the terminals on the DVD player and on the mobile telephone have coaxial contacts.
